(19) United States
(12) Patent Application Publication
(10) Pub. No.: US 2011/0116117 A1
(43) Pub. Date: May 19, 2011

(54) System and method for depositing solidifiable translucent fluid with a determined thickness

(75) Inventors: Edmond ABERGEL, Paris (FR); Raphael Renaud, Poitiers (FR)

(73) Assignee: MGI FRANCE, Ivry Sur Seine (FR)

(21) Appl. No.: 12/949,043

(22) Filed: Nov. 18, 2010

(30) Foreign Application Priority Data
Nov. 19, 2009 (FR) 0905555

(51) Int. Cl. H04N 1/60

(52) U.S. Cl. 358/1.9

(57) ABSTRACT

The present invention relates to an Inkjet printing system for obtaining a finished product comprising:
A printing station using nozzles with liquid ink for inkjet printing of at least one image on the surface of a suitable substrate, characterized in that the system also includes:
   At least a first deposit station with nozzles depositing a variable thickness of a solidifying translucent liquid on the substrate surface to produce a finished product without relief, positioned upstream of the drying station of the printed image relative to the direction of movement of the substrate in the system.

The present invention relates to the field of inkjet printers and more particularly to the field of coating deposit systems during inkjet printing.

Currently, an Inkjet print on a so called “closed” surface, such as different types of plastics or papers which the surfaces are not prepared to receive an impression poses several problems.

The inkjet deposit requires a thickness of about fifteen microns per color of ink deposited, as opposed to a thickness of five microns in the context of a traditional offset printing, which leads to a variation of the thickness of the printing of the order of sixty microns to print in color between a printed region and a non-printed, and thus the formation of a raised effect on the substrate. Moreover, if the printing is done on a “closed” substrate, the ink drops do not penetrate through the substrate surface and has a spread effect on the substrates surface, which leads to a problem with printing accuracy.

An alternative to circumvent this problem could be to use a paper-like fibrous substrate to obtain a better attachment to the substrate. However, the projected ink through the nozzles will penetrate the substrate, which would also alter the quality of printing on the substrate. Moreover, by reducing the surface tension of the ink to limit its penetration into the substrate, the ink would remain in effect embossed on the surface of the printed substrate.

In offset printing, the ink deposited is a layer with a thickness of the order of ten microns on the surface and leaves an embossed effect, which again penetrates into the substrate when it is absorbed. The document U.S. Pat. No. 7,451,698 proposes an offset print that can be partially covered with a layer of varnish forming a pattern. However, such a printing process, beyond the simple fact that it is not suitable for current inkjet printing devices and it is a strictly for aesthetic purposes, does not solve either the problem of the fixing and migration of the ink when printed on a closed substrate, nor the problem of ink absorption when printed on a fibrous paper substrate type. Such a process does not yield substantial improvements in quality, or the tactile and visual impression of the finished product, especially when the substrate used is a closed substrate.

The present invention aims to at resolve one of the drawbacks of known solutions by providing an inkjet printing ink to dispense with a step treatment of the substrate surface or a finishing step additional product out of the printing machine.

This objective is achieved by a jet printing system for obtaining a finished to product comprising:
A printing station using nozzles of the liquid printing ink with inkjet at least one image on the surface of a suitable substrate,
   characterized in that the system also includes:
At least a first deposit station by a fan nozzles variable thickness of a solidifying translucent liquid on the surface of substrate to produce a finished product without relief, positioned upstream the job of drying the printed image relative to the direction of moving the substrate in the system.

According to a particular embodiment, the inkjet print system is designed to obtain a finished product that is characterized that the system includes means for controlling the deposit of solidifiable translucent fluid controlled by a processing device, taking into account on one hand the areas not provided with ink and as well as the number of colors in the areas provided with ink to determine the thickness of the fluid layer deposited in that area as to obtain the same thickness in areas both provided and not provided with ink cartridges. In a first embodiment, the inkjet printing system is to obtain a finished product that is characterized in that the system includes means for controlling the deposit of solidifiable translucent fluid controlled by a device for image processing printed or print includes a conversion of the images gray level and a component for calculating the negative of the image converted. In a second variant, the inkjet printing system is to obtain a finished product is characterized in that the system includes a second deposit station in an area, a thickness of solidifiable translucent fluid controlled proportionally to the thickness of ink that will be subsequently filled in the area, this station being positioned upstream of the print station the image on the substrate relative to the moving direction of the substrate in the system.

According to a particular embodiment, the inkjet printing system is to obtain a finished product that is characterized in that the first deposit station of solidifiable translucent fluid is positioned between the printing station of the image on the substrate and the drying station of image printed on the substrate surface.

In another particular embodiment, the inkjet printing system is to obtain a finished product that is characterized in that the system includes a processing device of the printed image or printed by the print station in order to determine variation the thickness of the translucent ink deposited by at least one deposit station ink according to the printed image or print.

In another particular embodiment, the inkjet print system for obtaining a finished product is characterized in that the nozzles of the system are arranged in a ramp and selectively controlled depending on the file of the printed image or print or negative depending on the image file of that image.

In another particular embodiment, the inkjet print system for obtaining a finished product that is characterized in that the nozzles of the system are arranged to deposit a fluid with a translucent solidifiable surface tension included 15 and 28 mN/m at 23° C.

In another particular embodiment, the inkjet print system for obtaining a finished product is characterized in that the system comprises a position of solidification of solidifying translucent fluid specifically introduced by the second deposit station, upstream, filling solidifiable translucent fluid relative to the direction of movement of the substrate in the system.

In another particular embodiment, the inkjet print system for obtaining a finished product that is characterized in that the position of solidification involves UV radiation to allow a polymerization reaction and/or stiffening of the solidifiable translucent fluid image printed and/or translucent ink mark.

Another object of the invention is to provide a method for obtaining a printed product with the finished surface that is flat. This objective is achieved by an ink jet printing process and is to obtain a finished product with a surface treatment that is exempt from the prior art including:
A step for printing with ink to print at least one image on the surface of a suitable substrate,
wherein the method further comprises:
At least one step of depositing a variable thickness of a solidifying translucent fluid to obtain a finished product with no relief on the surface of the substrate positioned before the step of drying the printed image.

According to a particular embodiment, the inkjet printing process is to obtain a finished product that is characterized in that a step of depositing a variable thickness of translucent solidifying fluid before the printing step of image on the substrate.

According to a particular embodiment, the ink jet printing process for obtaining a finished product is characterized in that the step of depositing a variable thickness of the solidifiable translucent fluid completed following the printing of the image onto the substrate and precedes the step of drying the printed image onto the substrate.

According to a particular embodiment, the inkjet printing process is to obtain a finished product that is characterized in that the method comprises a step of processing the printed image or print at the impression stage so as to define a variation of the thickness of the solidifiable translucent fluid filed in at least one step of depositing ink depending on printed image or print.

According to a particular embodiment, the inkjet printing process for obtaining a finished product is characterized in that the processing step takes into account both the areas not provided with ink and on the other hand the number of colors in the areas provided with ink, to determine the thickness of the layer of fluid deposited in that area so as to achieve the same thickness in areas provided and not provided with ink cartridges.

According to a particular embodiment, the inkjet printing process for obtaining a finished product is characterized in that the step of processing the printed image or printing includes a step of converting the image grayscale as well as a step consisting of calculating the negative of the image converted.

According to a particular embodiment, the inkjet printing process for obtaining a finished product is characterized in that at least one stage of solidification of the solidifiable translucent fluid filled each succeeding step of depositing a solidifiable translucent fluid.

According to a particular embodiment, the method of inkjet printing to obtain a finished product is characterized in that the steps of solidifying the solidifying translucent fluid deposited are made early enough to avoid a spreading of the solidifiable translucent fluid printed image get a matte surface product and/or satin.

According to a particular embodiment, the method of inkjet printing to obtain a finished product is characterized in that the steps or solidifying the solidifying translucent fluid deposited is made once the fluid had the solidifying translucent fluid has had enough time to be spread over the printed image to get a product with a smooth surface and/or glossy.

The invention, its features and its advantages will emerge more clearly from reading the description made with reference to the accompanying drawings in which:

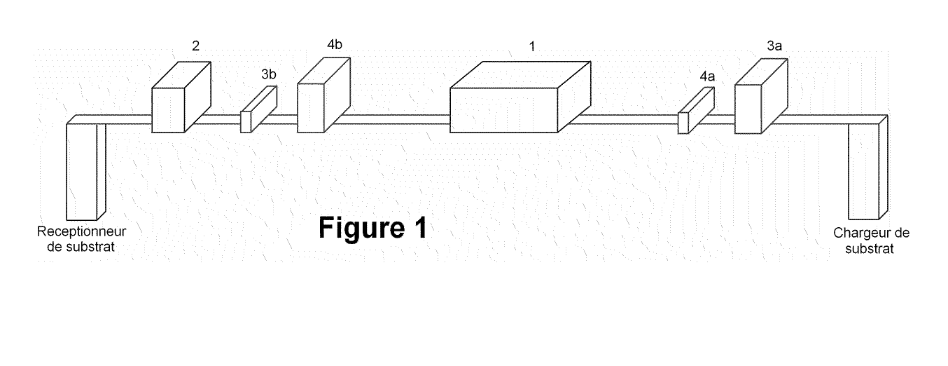

FIG. 1 shows a general diagram of a printing system according to the invention,

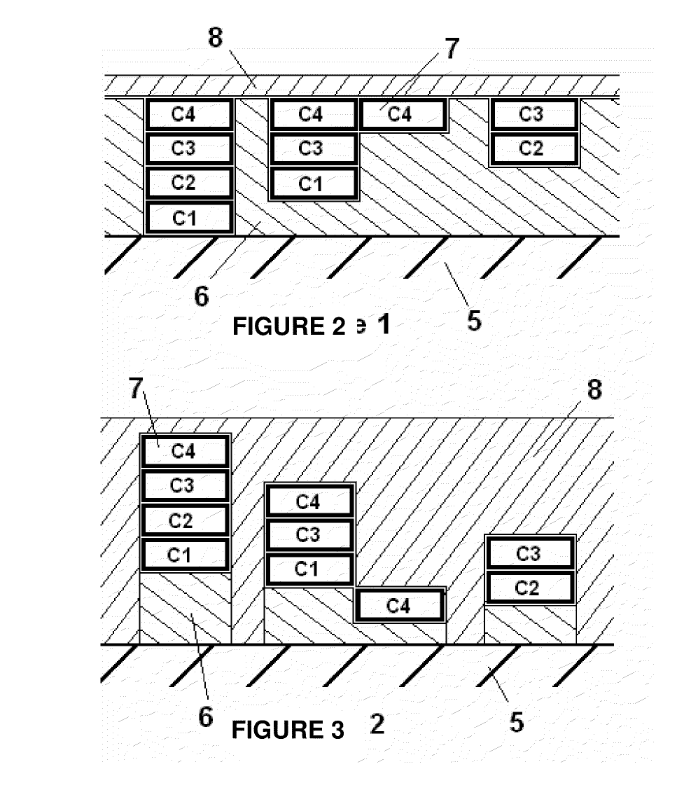

FIG. 2 shows schematically a section representing the deposit layers of a printed product according to a first variant of the inventive process,

FIG. 3 shows schematically a section representing the deposit layers of a printed product according to a second variant of the inventive process.

It is first to consider in this paper, the term “solidifiable translucent fluid” can be applied to varnishes and other products for viscous transparent overlays substrate surfaces. Solidification of translucent fluid may be affected by heating due to evaporation of the constituents of the fluid. However, according to a preferred procedure, the fluid solidifies operates by polymerizing at least one of its constituents such as the effect of ultraviolet radiation. The fluid used has a translucent surface tension between 15 and 28 mN/m at 23° C., preferably between 20 and 28 mN/m, to limit its eventual absorption by the substrate (5) to print.

These substrates (5) can be, for example and without limitation, non-fibrous support, for example but not limited to plastic, polycarbonate, PVC, polyester, with some flexibility. Such substrates are called substrates closed.

The present invention relates to a printing device for the filling of such translucent ink on the surface of a printed substrate or intended to be so that the finished surface is obtained without relief.

Inkjet Printing Systems that are state of the art include a “blank” charger substrate to be printed, the magazine being located upstream of the system and a recovery of the substrate when printed located downstream of the system.

According to a particular embodiment, the substrate is moved between different positions by successive means of transport or drive to the substrate, such as a treadmill, or vice versa, by moving the different positions of the printing system over a substrate which remains fixed. Between the feeding of the substrate and the recovery device, the inventive system includes a printing station (1) inkjet substrate. In one particular embodiment not limiting the printing station (1) is arranged to allow color printing substrate. This Printing post (1) is associated with a drying station (2) of the printed image on the substrate.

Compared with this printing system known to the state of the art, the distinctive feature of the invention is to incorporate at least one deposit station (3a, 3b) solidifiable translucent fluid (6, 8) on the substrate (5) so that the step of depositing the translucent fluid (6, 8) is made before the substrate (5) is printed and has undergone a drying step at the station (2) adapted to this function. In addition, the deposit (3a, 3b) of solidifying translucent fluid (6, 8) on the substrate is performed so that the thickness of the translucent ink is is variable.

The solidifiable translucent fluid (6) is deposited with a relief. However, the relief obtained in the deposit (3) translucent fluid may be preset and controlled from specific parameters, as explained below in the document. Moreover, According to a particular embodiment, the deposit station (3a, 3b) of solidifying translucent fluid on the substrate can be associated with a position of solidification (4a, 4b) of the translucent fluid deposited. This position of solidification (4a, 4b) is then positioned downstream of the deposit station (3a, 3b) of the translucent fluid (6, 8) relative to the direction of movement of the substrate (5) in the system. Without limitation, the solidification device (4a, 4b) used involves a UV (ultraviolet) to conduct a polymerization of at least one of the compounds of the solidifying translucent fluid (6) and therefore a stiffening of the ink the printed image.

Thus, according to a particular embodiment, the inventive system comprises a first deposit station (3b) of solidifying translucent fluid (6) positioned downstream of print station (1) ink jet on the substrate (5), but upstream of the drying station (2) of the printed ink, relative to the direction of movement of the substrate in the system. This particular positioning of the deposit station (3b) of solidifying translucent fluid (6) allows the recovery of the printed substrate by a layer of solidifiable translucent fluid (6) which allows to obtain the desired type of finish for the product explained below in the document.

In a second variant, the inventive system includes a second deposit station (3a) of solidifying translucent fluid (6) positioned upstream of the inkjet printing station (1) on the substrate (5) relative to the direction of movement of the substrate in the system. This particular positioning of the deposit station (3) solidifying the translucent fluid (6) allows on one hand to cover the substrate with a layer of fluid (6) whose thickness facilitates the adhesion of the printed image to the substrate (5) at the print station (1), and also improves the qualitative impression with a deposit of solidifiable translucent fluid in relief (6), so as to prevent the escape of the printing ink (7).

In both variants previously mentioned, deposits of solidifying translucent fluid (6) are made so that the thickness is variable and allows for removal of all variations of relief on the surface of the substrate (5) that result from deposit inks, such as color, when printed. Moreover, the recovery of the impression of a layer of solidifiable translucent fluid (8) allows one to obtain a substrate (5) provided with a printed surface without relief and hence to obtain a finished product valued.

According to one particular embodiment, the inventive system includes a first deposit station (3b) solidifiable translucent fluid (8) positioned downstream of the inkjet print station (1) on the substrate (5) and a second deposit station (3a) of solidifying translucent fluid (6) positioned upstream of the inkjet printing station (1).

The second deposit station (3a) of solidifying translucent fluid (6) allows through a deposit of varying thickness, to overcome variations in relief of the printed substrate, while the first position (3b) solidifiable translucent fluid (8) allows to make a deposit of surface finish of the product. According to a variant of this embodiment, each of these positions of deposit (3a, 3b) solidifiable translucent fluid (6, 8) is likely to be associated with a position of solidification (4a, 4b) respectively.

According to a particular embodiment, the variation of the thickness of solidifying translucent fluid (6) deposited on the substrate by the second deposit station (3a) is defined from at least one particular parameter. This parameter is the image printed by the printing station. The system, according to the invention, connects with either the printing station or the solidifiable translucent fluid deposit stations (3a, 3b), either directly or indirectly via a central unit, so a file of the printed image or print of this image file is transmitted to the solidifiable translucent fluid deposit stations (3a, 3b). With a suitable device for the treatment of the printed image or to print a map of the surface of the substrate (5) with different variations of the thickness of solidifiable translucent fluid may be established so that the superposition of fluids translucent and printing inks lead to a smooth, flat surface. The treatment used preferentially involves a first step of converting the monochrome image, also called grayscale, and a second step of calculating the negative of the image converted. The image obtained after treatment corresponds to the negative of the printed image converted to grayscale. The translucent ink deposited on the substrate according to a map corresponding to the image obtained after treatment can then compensate for differences in relief of the substrate once it is printed.

According to an alternative method, five files are extracted from the printed image or print. A first file is a mapping of all points of the printed image or to print including all four colors of ink. A second file is a mapping of all points of the printed image or print that includes only three colors of ink. A third file corresponds to a mapping of all points of the printed image or print that includes only two colors of ink. A fourth file is a mapping of all points of the printed image or print that includes one color of printing ink, and a final and fifth file is a mapping of all points of printed image or print that have no ink. From these extracted files, the thickness of translucent ink drop determined by the processing device is inversely proportional to the number of colors used in printing ink.

The processing steps of the printed image or print are made in a suitable device with elements of calculation, conversion and/or appropriate treatment for achieving these steps. This device is adapted to be positioned in a central unit that manages the delivery of the finished product being connected to multiple positions (1, 2, 3a, 3b, 4a, 4b) of the system, either at positions involved in the system.

According to a particular embodiment, the method used to obtain the finished product also involves a spreading factor of solidifying translucent fluid on the printing ink after posting of the printing ink. The conservation of this effect during the process can lead to a finished product where the resulting surface is smooth and glossy. This physical phenomenon can be slowed or stopped by the solidification process (4a, 4b), which stiffens the translucent ink deposited, increases the surface tension and eliminates the possibility of spreading. By preventing the sprawl phenomenon, the solidification of the fluid has the advantage of obtaining a finished product whose surface is matte and satin. The presence or absence of solidification is therefore particularly important in determining the surface finish of substrate (5) printed.

Moreover, when the solidification step is performed by the appropriate post (4a) prior to the step of printing the image onto the substrate surface, the relief obtained by the thickness variations of translucent ink is deposited more easily maintained to allow compensation of relief created by the deposit of ink (7) during the printing step (1). The deposit variable (3a) of solidifying translucent fluid (6) on the substrate (5) can be realized in two different operating modes shown in FIGS. 2 and 3.

According to a first operating mode shown in FIG. 2, the second deposit station (3) of translucent fluid (6) makes a deposit of fluid so that the superposition of the fluid layer (6) and deposited layers (c1, c2, c3, c4) Ink (7) print the points considered to lead to the same thickness over the entire surface of the substrate (5) printed. The varying thicknesses of translucent fluid (6) are deposited as multiple drop zones prepared to receive a predetermined number of layers (c1, c2, c3, c4) of ink (7) printing. Areas of the substrate surface (5) not being covered with ink show the thickness of the translucent fluid is greater. Conversely, the areas provided with four ink colors of color printing are, the thickness of fluid (6) is lower, even zero. The image obtained during the deposit of solidifiable translucent fluid (6) corresponds to the negative of the printed image, or to be printed, converted to grayscale and is used to compensate for differences in relief of the substrate once it is printed. After printing, the uniform surface of the print (5) can then be covered with another layer uniform (8) solidifiable translucent fluid by the first deposit station (3b).

In a second procedure shown in FIG. 3, the second translucent fluid (6) deposit station (3) makes a deposit of fluid so that the thickness of the layer of fluid (6) deposited is proportional to the number of layers (c1, c2, c3, c4) of ink (7) points considered, regardless of the final thickness with cumulative thickness of the fluid deposited and the thickness of different layers (c1, c2, c3 c4) of ink (7) printing.

Variations in the thickness of the layer of fluid (6) are then filled after the deposit step of printing ink (7). The suppression of this relief to obtain a uniform surface is obtained by depositing a second layer of solidifiable translucent fluid (8) with the first deposit station (3b), which compensates for variations in relief on the surface substrate (5) printed.

In both procedures detailed variation in thickness of solidifiable translucent fluid (6) filled to define the different ink zones based on the number of layers of ink deposited. The filing of this fluid layer is usually followed by a solidification of the fluid, the printing ink (7) which is then filed this spreading and evasion that is reduced or eliminated because of the large-area tension (between 15 and 28 mN/m) of the fluid which categorizes the print areas based on the number of layers of ink (c1, c2, c3, c4) (7) deposited.

It should be obvious to those skilled in the art that the present invention allows embodiments in numerous other specific forms without departing from the scope of the invention as claimed. Therefore, these embodiments should be considered illustrative but can be modified in the field defined by the scope of the appended claims.

1. Inkjet printing system designed to obtaining a finished product comprising:
a. A printing station using nozzles of liquid ink for inkjet printing of at least one image on the surface of a suitable substrate, characterized in that the system also includes:
i. At least a first deposit station with nozzles for depositing a variable thickness of a solidifying translucent liquid on the substrate surface, the thickness being controlled by a control means, to remove all changes in relief on the substrate surface resulting in the deposition of ink when printing and getting a finished product without relief, with the position of filing a solidifiable translucent fluid being positioned upstream of the drying station of the printed image relative to the direction displacement of the substrate in the system.

2. Inkjet printing system designed for obtaining a finished product according to the preceding claim, wherein the system comprises means for controlling the deposition of solidifiable translucent fluid controlled by a processing device, taking into account both areas not provided with ink and secondly the number of colors in areas provided with ink, to determine the thickness of the layer of fluid deposited in that area so as to achieve the same thickness in the areas designated for Ink and those areas designated for no ink.

3. Inkjet printing system designed for obtaining a finished product according to the preceding claim, wherein the system comprises means for controlling the deposition of the solidifiable translucent fluid controlled by a processing device of the printed image or print includes a conversion of the image grayscale and a component for calculating the negative of the converted image.

4. Inkjet printing system designed for obtaining a finished product according to claim 1-2, characterized in that the printing system includes a second deposit station in an area with a thickness of solidifiable translucent fluid controlled proportionally to the thickness of ink to be deposited later in the area, this station being positioned upstream of the printing station of the image on the substrate relative to the direction of movement of the substrate in the system.

5. Inkjet printing system designed for obtaining a finished product according to any of the preceding claims, characterized in that the first deposition station solidifiable translucent fluid is positioned between the printing station of the image on the substrate and the drying station of the image printed on the substrate surface.

6. Inkjet printing system designed for obtaining a finished product according to any of the preceding claims, characterized in that the system includes a processing device or the printed image to be printed by the print station in order to determine a variation of the thickness of solidifiable translucent fluid filled by at least one deposition station according to the printed image or print.

7. Inkjet printing system designed for obtaining a finished product according to any of the preceding claims, characterized in that the nozzles of the system are arranged in a ramp and selectively controlled depending on the file of the printed image or print or depending on image file negative image.

8. Inkjet printing system designed for obtaining a finished product according to any of the preceding claims, characterized in that the nozzles of the system are arranged to deposit a solidifiable translucent fluid on a surface tension included 15 and 28 mN/m at 23° C.

9. Inkjet printing system designed for obtaining a finished product with a surface treatment is exempt from the prior art including:
a. A step for printing with ink to print at least one image on the surface of a suitable substrate,
wherein the method further comprises:
i. At least one step of depositing a variable thickness of a solidifying translucent fluid, the thickness being controlled by a control means, to remove all changes in relief on the surface of the substrate resulting in the deposition of ink printing and get a finished product with no relief on the surface of the substrate positioned before the step of drying the printed image.

10. Inkjet printing system designed for obtaining a finished product according to the preceding claim, wherein a step of depositing a variable thickness of solidifiable translucent fluid precedes step of printing the image on the substrate.

11. Inkjet printing system designed for obtaining a finished product according to claim 9-10, wherein the step of depositing a variable thickness of solidifying translucent fluid is performed after printing of the image on the substrate and precedes the step of drying the printed image on the substrate surface.

12. Inkjet printing system designed for obtaining a finished product according to claim 9-11, characterized in that the method comprises of a step processing the printed image at the printing step to define a variation of the thickness of solidifiable translucent fluid filled in at least one step of ink depositing depending on printed image or print.

13. Inkjet printing system designed for obtaining a finished product according to claim 12, wherein the processing step takes into account both the areas not covered with ink and secondly the number of colors in areas provided with ink, to determine the thickness of the layer of fluid deposited in that area so as to achieve the same thickness in areas provided and not provided with ink coverage.

14. Jet printing process for obtaining a finished product according to claim 12, wherein the step of processing the printed image or printing includes a step of converting the image into grayscale and a step of calculating the negative of the image converted.

14. Inkjet printing system designed for obtaining a finished product according to claim 9-14, characterized in that at least one stage of solidification of the solidifiable translucent fluid deposit succeeds at every step of depositing a solidifiable transparent fluid.
